(19) United States
(12) Patent Application Publication
(10) Pub. No.: US 2017/0167796 A1
(43) Pub. Date: Jun. 15, 2017

(54) RADIATOR FOR VEHICLE

(71) Applicants: Hyundai Motor Company, Seoul (KR); Kia Motors Corporation, Seoul (KR); Hanon Systems, Daejeon (KR)

(72) Inventors: Jae Yeon Kim, Hwaseong (KR); Wan Je Cho, Hwaseong (KR); Yeon Ho Kim, Seoul (KR); Jeong Wan Han, Daejeon (KR); Jae Yong Kim, Daejeon (KR); Sang Ok Lee, Daejeon (KR)

(21) Appl. No.: 15/206,803

(22) Filed: Jul. 11, 2016

(30) Foreign Application Priority Data
Dec. 10, 2015 (KR) 10-2015-0176335

(51) Int. Cl. F28D 7/00; F28F 9/02; B60H 1/00

(52) U.S. Cl. CPC F28D 7/0066; B60H 1/00328; F28F 9/02

(57) ABSTRACT

A radiator for a vehicle is provided. The radiator includes a first header tank that has an inlet port formed at a first side thereof to allow a coolant to flow from an engine thereinto and an outlet port formed at a second side thereof to allow the coolant to flow to the engine. A second header tank is disposed apart from the first header tank. A heat-exchanging portion fluidly connects the inlet tank and the outlet tank and includes a plurality of tubes and radiation fins to cool the coolant flowing in the tubes by exchanging heat with air. A diaphragm unit is disposed at the inside of the first header tank to prevent the coolant which flows into the inlet port from being mixed with the coolant which is exhausted from the outlet port.

### CROSS-REFERENCE TO RELATED APPLICATION

This application claims priority to and the benefit of Korean Patent Application No. 10-2015-0176335 filed in the Korean Intellectual Property Office on Dec. 10, 2015, the entire contents of which are incorporated herein by reference.

### BACKGROUND

(a) Field of the Invention

The present invention relates to a radiator for a vehicle, and more particularly, to a vehicle radiator that cools a coolant to be supplied to an engine.

(b) Description of the Related Art

Generally, a mixture of fuel and air is injected into a cylinder of an engine and explosive force produced when the mixture is burnt is delivered to a driving wheel in a vehicle to thus drive the vehicle. The engine includes a cooling apparatus such as a water jacket configured to cool the engine of a high temperature due to combustion of the mixture, and a coolant, a temperature of which is increased when circulating through the water jacket, is cooled by a radiator.

The radiator is divided into an air cooled radiator and a water cooled radiator based on a cooling type, and is divided into a cross-flow radiator and a down-flow radiator based on a flow direction of the coolant. The air cooled radiator is a radiator in which the coolant is cooled by air and is universally used for a small engine. The water cooled radiator is a radiator in which the coolant is cooled by an additional coolant and is used for a large engine. The cross-flow radiator and the down-flow radiator are determined based on a flow direction of the coolant.

According to a conventional radiator of the related art, an inlet tank into which the coolant flows and an outlet tank from which the coolant is exhausted or discharged are disposed spaced apart from each other, and a plurality of tubes are mounted between the inlet tank and the outlet tank to fluidly connect the inlet tank and the outlet tank. The coolant flows in the plurality of tubes and is cooled by exchanging heat with air.

The cross-flow radiator is a radiator with an inlet tank and outlet tank disposed at the left and right and the tubes are mounted horizontally within the radiator. Therefore, the coolant flows horizontally and is cooled in the cross-flow radiator. In addition, the down-flow radiator is a radiator within an inlet tank and outlet tank ae disposed at the top and the bottom and the tubes are mounted vertically within the radiator. Therefore, the coolant flows vertically and is cooled in the down-flow radiator.

The radiator is disposed in an engine compartment of the vehicle facing the front such that the coolant exchanges heat with cool air when the vehicle is being driven. The flow resistance of the coolant, which flows along a length direction of the inlet and outlet tanks, deteriorates heat exchanging performance according to a conventional radiator. Therefore, cooling efficiency of the radiator may be deteriorated. When cooling efficiency of the radiator is deteriorated, the coolant is supplied to the engine without being cooled to a demand temperature. Therefore, the engine may not be cooled and cooling performance of the vehicle may be deteriorated.

The above information disclosed in this section is merely for enhancement of understanding of the background of the invention and therefore it may contain information that does not form the prior art that is already known in this country to a person of ordinary skill in the art.

### SUMMARY

The present invention provides a radiator for a vehicle having advantages of improving cooling efficiency of the coolant to prevent mixing of inflow and exhausted coolant in a U-turn type of structure in which the coolant flows or is exhausted to one header tank.

A radiator for a vehicle according to an exemplary embodiment of the present invention may include: a first header tank having an inlet port formed at a first side thereof to allow a coolant to flow from an engine thereinto and an outlet port formed at a second side thereof to allow a coolant to flow to the engine; a second header tank disposed apart from the first header tank; a heat-exchanging portion that fluidly connects the inlet tank and the outlet tank and includes a plurality of tubes and radiation fins to cool the coolant flowing in the tubes by exchanging heat with air; and a diaphragm unit disposed at the inside of the first header tank to prevent the coolant which flows into the inlet port from being mixed with the coolant exhausted from the outlet port.

The first header tank and the second header tank may be include first and second header plates, which are connected with the tube, and first and second tank housings which are mounted at the first and second header plates. The diaphragm unit may include: a diaphragm that protrudes or extends from the first tank housing toward the first header plate to partition or divide the inside of the first tank housing with a space being communicated with the inlet port and a space being communicated with the outlet port; and a leak preventing member mounted to the diaphragm to allow a first end portion thereof, which protrudes from the diaphragm, to contact the interior surface of the first header plate.

Further, a mounting groove may be formed on the first end of the diaphragm which protrudes from the first tank housing. The leak preventing member may include: a first end portion as an insert portion inserted into the mounting groove; a contact portion integrally formed on a second end portion of the insert portion and connected with the interior surface of the first header plate; and a flange portion formed between the insert portion and the contact portion, and supported at the protruded first end of the diaphragm.

At least one catching protrusion may be integrally formed at the exterior circumference of the insert portion along the length direction. The shape of a cross-section of the catching protrusion may be a triangle shape which is inclined toward the first tank housing. Additionally, at least one catching projection may be formed to the mounting groove to correspond to the catching protrusion. The leak preventing member may be made of a rubber material. The inlet port may be disposed at the upper portion of the first header tank in the length direction, and the outlet port may be disposed at the lower portion of the first header tank in the length direction.

The present invention has been made in an effort to provide a radiator for a vehicle having advantages of improving cooling efficiency of the coolant to prevent mixing of the inflow and exhausted coolant in the U-turn type of structure in which the coolant flows or is exhausted to one header tank. In addition, the present invention has been made in an effort to provide a radiator for a vehicle having further advantages of improving cooling performance of the engine without increasing capacity of the radiator, reducing a size of the radiator, decreasing manufacturing cost, and improving utilization of space in an engine compartment by improving cooling efficiency of the coolant to cool the coolant to a demand temperature.

### BRIEF DESCRIPTION OF THE DRAWINGS

The above and other objects, features and advantages of the present disclosure will be more apparent from the following detailed description taken in conjunction with the accompanying drawings.

FIG. 1 is a front view of a radiator for a vehicle according to an exemplary embodiment of the present invention;

FIG. 2 is an enlarged cross-sectional view of a radiator for a vehicle of part A of FIG. 1 according to an exemplary embodiment of the present invention; and

FIG. 3 is an exploded sectional view of a diaphragm unit applied to a radiator for a vehicle according to an exemplary embodiment of the present invention.

### DESCRIPTION OF SYMBOLS

100: Radiator
110: First header tank
112: First header plate
114: First tank housing
116: Inlet port
118: Outlet port
120: Second header tank
122: Second header plate
124: Second tank housing
130: Heat exchange unit
132: Tube
134: Heat radiating fin
140: Diaphragm unit
141: Mounting groove
142: Diaphragm
143: Catching projection
144: Leak preventing member
145: Insert portion
146: Contact portion
147: Flange portion
148: Catching protrusion

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum). An exemplary embodiment of the present invention will hereinafter be described in detail with reference to the accompanying drawings. First, since the exemplary embodiment described in the specification and the configurations shown in the drawings are merely an exemplary embodiment and configurations of the present invention, they do not represent all of the technical ideas of the present invention, and it should be understood that that various equivalents and modified examples, which may replace the exemplary embodiments, are possible when filing the present application.

In order to clearly describe the present invention, parts that are irrelevant to the description are omitted, and identical or similar constituent elements throughout the specification are denoted by the same reference numerals. Since the size and thickness of each configuration shown in the drawings are arbitrarily shown for convenience of description, the present invention is not necessarily limited to configurations illustrated in the drawings, and to clearly illustrate several parts and areas, enlarged thicknesses are shown.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.” The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Furthermore, terms such as “ . . . unit”, “ . . . means”, “ . . . part”, and “ . . . member” described in the specification mean a unit of a comprehensive configuration having at least one function or operation.

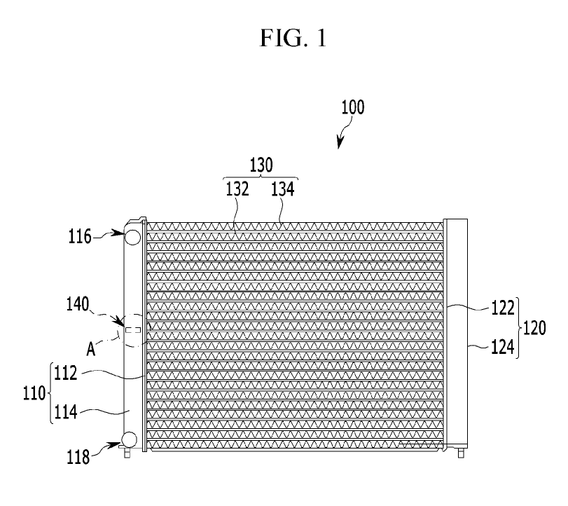

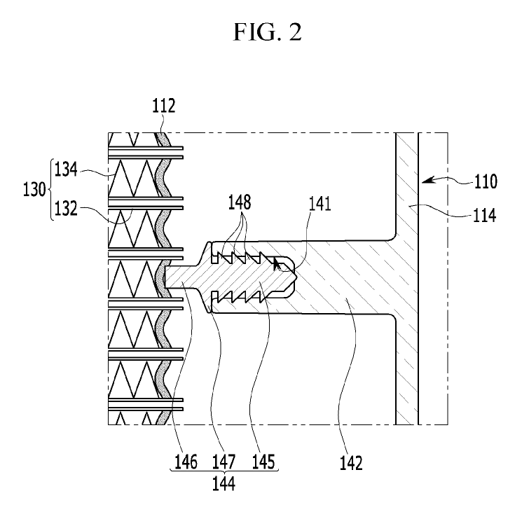

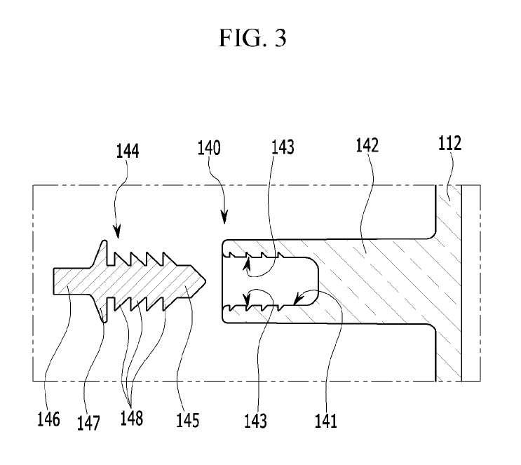

FIG. 1 is a front view of a radiator for a vehicle according to an exemplary embodiment of the present invention, FIG. 2 is an enlarged cross-sectional view of a radiator for a vehicle of part A of FIG. 1, and FIG. 3 is a exploded sectional view of a diaphragm unit applied to a radiator for a vehicle according to an exemplary embodiment of the present invention.

The radiator 100 for a vehicle according to an exemplary embodiment of the present invention may prevent mixing of inflow and exhausted coolant in the U-turn type of structure in which the coolant flows or is exhausted to one header tank to improve cooling efficiency of the coolant. Accordingly, as shown in FIG. 1, the radiator 100 for a vehicle according to an exemplary embodiment of the present invention may include first and second header tanks 110 and 120, and a heat exchange unit 130.

The first header tank 110 may have an inlet port 116 formed at a first side thereof to allow a coolant to flow from an engine thereinto and an outlet port 118 formed at a second side thereof to allow a coolant to flow to the engine. Particularly, the inlet port 116 may be disposed at the upper portion of the first header tank 110 in the length direction. The outlet 118 may be disposed at the lower portion of the first header tank 110 in the length direction. The second header tank 120 may be disposed apart from (e.g., spaced apart from) the first header tank 110.

The heat exchange unit 130 may be disposed between the first header tank 110 and the second header tank 120. Additionally, the heat exchange unit 130 may include a plurality of tubes 132 and heat radiating fins 134, and the coolant flowing through the tubes 132 may exchange heat with air. The heat exchanging unit 130 may connect inner sides of the first header tank 110 and the second header tank 120. In the present exemplary embodiment, the first header tank 110 and the second header tank 120 may include first and second header plates 112 and 122, connected with the tube 132, and first and second tank housings 114 and 124 mounted at the first and second header plates 112 and 122. A diaphragm unit 140 may be disposed at the inside of the first header tank 110 to prevent the coolant which flows into the inlet port 116 from being mixed with the coolant exhausted or discharged from the outlet port 118.

As shown FIG. 2 and FIG. 3, the diaphragm unit 140 may include a diaphragm 142 and a leak preventing member 144. The diaphragm 142 may be provided to partition the inlet and outlet ports 116 and 118. In addition, the diaphragm 142 may protrude or extend from the first tank housing 114 toward the first header plate 112 to partition or divide the inside of the first tank housing 114 with a space being communicated with the inlet port 116 and a space being communicated with the outlet port 118. A mounting groove 141 may be formed on a first end of the diaphragm 142 which protrudes from the first tank housing 114.

In the present exemplary embodiment, the leak preventing member 144 may be mounted to the mounting groove 141 of the diaphragm 142. A first end portion of the leak preventing member 144, which protrudes from the diaphragm 142, may contact the interior surface of the first header plate 112. The leak preventing member 144 may include an insert portion 145, a contact portion 146, and a flange portion 147.

Further, a first end of the insert portion 145 may be inserted into the mounting groove 141. At least one catching protrusion 148 may be integrally formed at the exterior circumference of the insert portion 145 along the length direction. A plurality of catching protrusions 148 may be formed to be spaced apart from each other along the length direction of the insert portion.

Additionally, the catching protrusion 148 may include a slanted surface which is inclined upward from the first tank housing 114 toward the first header plate 112, and a vertical surface which vertically connects the slanted surface and the insert portion 145. Accordingly, the shape of a cross-section of the catching protrusion 148 may be a triangle shape which is inclined toward the first tank housing 112. At least one catching projection 143 may be formed to the mounting groove 141 to correspond to the catching protrusion 148. The catching projection 143 may be formed with the same shape as the catching protrusion 148.

When the insert portion 145 is inserted into the mounting groove 141, the catching protrusions 148 may be fixed with the catching projections 143 in a locking state locked to prevent the leak preventing member 144 from separating from the mounting groove 141. In the present exemplary embodiment, the contact portion 146 may be integrally formed on a second end portion of the insert portion 145. The contact portion 146 may be connected with the interior surface of the first header plate 112.

The flange portion 147 may be formed between the insert portion 145 and the contact portion 146, and may be supported at the protruded first end of the diaphragm 142. In addition, the flange portion 147 may prevent insertion of the insert portion 145 to be more (e.g., deeper) than a predetermined depth into the inside of the mounting groove 141. The flange portion 147 may be configured to prevent the insert portion 145 from being inserted more than a predetermined depth into the inside of the mounting groove 141. Furthermore, the flange portion 147 may prevent the coolant from flowing into the inside of the mounting groove 141.

The leak preventing member 144 having a configuration as described above may be made of a rubber material having an elastic force. Accordingly, when the first header plate 112 is assembled with the first tank housing 114, the leak preventing member 144 may partition the inside of the first header tank 110 to be airtight for preventing the coolant from being mixed through a predetermined gap applied for assembly tolerance and interference. In other words, the diaphragm unit 140 may prevent mixing of the coolant which flows into the inlet port 116 and the cooled coolant cooled by passing through the heat exchange unit 130 to be exhausted to the outlet port 118.

When the radiator 100 for the vehicle according to exemplary embodiments of the present invention is used, the radiator 100 may prevent mixing of the inflow and exhausted coolant in the U-turn type of structure in which the coolant flows or is exhausted to the first header tank 110. Therefore, cooling efficiency may be improved. Since the radiator 100 according to exemplary embodiments of the present invention may cool the coolant to the demand or predetermined temperature by improving cooling efficiency of the coolant, cooling performance of the engine may be improved without increasing capacity of the radiator, the size of the radiator may be reduced, manufacturing cost may be decreased, and utilization of space in an engine compartment may be improved.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A radiator for a vehicle, comprising:
a first header tank having an inlet port formed at a first side thereof to allow a coolant to flow from an engine thereinto and an outlet port formed at a second side thereof to allow the coolant to flow to the engine;
a second header tank disposed apart from the first header tank;
a heat-exchanging portion that fluidly connects the inlet tank and the outlet tank and includes a plurality of tubes and radiation fins to cool the coolant flowing in the tubes by exchanging heat with air; and
a diaphragm unit disposed at the inside of the first header tank to prevent the coolant which flows into the inlet port from being mixed with the coolant which is exhausted from the outlet port.

2. The radiator of claim 1, wherein the first header tank and the second header tank include first and second header plates, which are connected with the tube, and first and second tank housings which are mounted at the first and second header plates.

3. The radiator of claim 2, wherein the diaphragm unit includes:
a diaphragm that protrudes from the first tank housing toward the first header plate to partition the inside of the first tank housing with a space being communicated with the inlet port and a space being communicated with the outlet port; and
a leak preventing member mounted to the diaphragm to allow the first end portion thereof, which protrudes from the diaphragm, to contact the interior surface of the first header plate.

4. The radiator of claim 3, wherein a mounting groove is formed on the first end of the diaphragm which protrudes from the first tank housing.

5. The radiator of claim 4, wherein the leak preventing member includes:
a first end portion as an insert portion inserted into the mounting groove;
a contact portion integrally formed on a second end portion of the insert portion and connected with the interior surface of the first header plate; and
a flange portion formed between the insert portion and the contact portion, and supported at the protruded first end of the diaphragm.

6. The radiator of claim 5, wherein at least one catching protrusion is integrally formed at the exterior circumference of the insert portion along the length direction.

7. The radiator of claim 6, wherein the shape of a cross-section of the catching protrusion is a triangle shape which is inclined toward the first tank housing.

8. The radiator of claim 6, wherein at least one catching projection is formed to the mounting groove to correspond to the catching protrusion.

9. The radiator of claim 3, wherein the leak preventing member is made of a rubber material.

10. The radiator of claim 1, wherein the inlet port is disposed at an upper portion of the first header tank in the length direction, and the outlet port is disposed at a lower portion of the first header tank in the length direction.
